(19) United States
(12) Patent Application Publication
(10) Pub. No.: US 2026/0143430 A1
(43) Pub. Date: May 21, 2026

(54) METHOD, APPARATUS, AND SYSTEM FOR COMMUNICATION DEVICE WAKE-UP

(71) Applicant: Huawei Technologies Co., Ltd., Shenzhen (CN)

(72) Inventors: Shahram Shahsavari, Ottawa (CA); Alireza Bayesteh, Brossard (CA); Jianglei Ma, Ottawa (CA); Wen Tong, Ottawa (CA)

(21) Appl. No.: 19/452,659

(22) Filed: Jan. 19, 2026

Related U.S. Application Data
(63) Continuation of application No. PCT/CN2024/083861, filed on Mar. 26, 2024.
(60) Provisional application No. 63/514,845, filed on Jul. 21, 2023.

(51) Int. Cl. H04W 52/02

(52) U.S. Cl. CPC H04W 52/0235

(57) ABSTRACT

Embodiments of the present application provide a communication method and a communication apparatus. The method includes: receiving, in a first mode, a wake-up signal including a prefix part and a signature part, where the prefix part includes at least one linear frequency modulated (LFM) signal and the signature part includes at least one LFM signal; obtaining timing offset of the wake-up signal based on at least one LFM signal in the prefix part; obtaining at least one parameter associated with at least one LFM signal in the signature part based on the timing offset; and transitioning from the first mode to a second mode based on the at least one parameter. The receiving apparatus can process the whole wake-up signal (including the prefix part and the signature part) in a same way, and can obtain a timing offset to perform the rest of the WU procedure.

### CROSS-REFERENCE TO RELATED APPLICATIONS

The present application is a continuation of International Patent Application PCT/CN2024/083861, entitled “Method, Apparatus, and System for Communication Device Wake-Up,” filed on Mar. 26, 2024, and claims the benefit of U.S. Patent Application No. 63/514,845, entitled “Methods, Apparatus, and Systems for Wake-Up Signal Frame Structure with Prefix,” filed on Jul. 21, 2023.

The entire contents of the aforementioned applications are hereby incorporated by reference.

### TECHNICAL FIELD

Embodiments of the present application relate to the field of communications, and more specifically, to a communication method and a communication apparatus.

### BACKGROUND

In a communication system, a node may transition into a low-power mode (for example, an idle mode, an inactive mode or other low-power modes) to reduce the power consumption. A node in the low-power mode monitors wake-up signal (WUS), where the WUS is used to trigger the node to exit the low-power mode. This procedure in which a node is woken up may be called a wake-up (WU) procedure. The processing of the WUS may depend on time synchronization between the receiving side and transmitting side of the WUS. A timing offset between the receiving side and the transmitting side may cause an abnormal WU procedure.

Performing synchronization before the processing of the WUS may improve the reliability of the WU procedure. However, using an additional signal to perform synchronization may increase the complexity and power consumption of the WU procedure. Therefore, how to reduce the complexity and power consumption of the WU procedure becomes an urgent problem to be solved.

### SUMMARY

Embodiments of the present application provide a communication method and a communication apparatus. The technical solutions may reduce the complexity and power consumption of a WU procedure.

According to a first aspect, an embodiment of the present application provides a communication method, and the method may be performed by a receiving apparatus. The method includes: receiving, in a first mode, a wake-up signal including a prefix part and a signature part, where the prefix part includes at least one linear frequency modulated (LFM) signal and the signature part includes at least one LFM signal; obtaining timing offset of the wake-up signal based on at least one LFM signal in the prefix part; obtaining at least one parameter associated with at least one LFM signal in the signature part based on the timing offset; and transitioning from the first mode to a second mode based on the at least one parameter.

According to a second aspect, an embodiment of the present application provides a communication method, and the method may be performed by a transmitting apparatus. The method includes: transmitting a wake-up signal including a prefix part and a signature part, where the prefix part includes at least one linear frequency modulated (LFM) signal, the signature part includes at least one LFM signal, timing offset of the wake-up signal is obtained from at least one LFM signal in the prefix part, at least one parameter associated with at least one LFM signal in the signature part is obtained based on the timing offset, and the at least one parameter is used for a receiving apparatus to transition from a first mode to a second mode.

According to the above technical solution, a prefix part before the signature part is included in the wake-up signal, so that at least one parameter associated with at least one LFM signal in the signature part can be obtained based on a timing offset obtained from at least one LFM signal in the prefix part. That is, the receiving apparatus can process the whole wake-up signal (including the prefix part and the signature part) in a same way, and can obtain a timing offset to perform the rest of the WU procedure. In other words, the synchronization can be performed as a part of the WU procedure in a simple and low consumption way. Thus, complexity and power consumption of the WU procedure can be reduced.

With reference to the first aspect or the second aspect, in some embodiments, the signature part includes at least one symbol, and each symbol includes an LFM signal among the at least one LFM signal in the signature part.

According to the above technical solution, the at least one LFM signal in the signature part is associated with at least one symbol of the signature part. Thus, the receiving apparatus can determine the position of each LFM signal in the signature part based on symbol boundaries obtained by performing synchronization.

With reference to the first aspect or the second aspect, in some embodiments, an LFM rate of the first LFM signal in the prefix part and an LFM rate of the LFM signal in the first symbol of the signature part are the same, and an initial frequency of the first LFM signal in the prefix part meets the following formula:

$${f}_{p r}^{′} = {f}_{1} + {α}_{1} ( {T}_{1} - {T}_{p r}^{′} )$$

$${f}_{p r}^{′}$$

is the initial frequency of the first LFM signal in the prefix part. f₁ is an initial frequency of an LFM signal in the first symbol of the signature part. α₁ is the LFM rate of the LFM signal in the first symbol of the signature part. T₁ is a time duration of the first symbol in the signature part.

$${T}_{p r}^{′}$$

is a time duration of the first LFM signal in the prefix part, and

$${T}_{p r}^{′}$$

is less than or equal to T₁.

According to the above technical solution, the phase is continuous between the first symbol and subsequent symbol of prefix part. Thus, the operation of the receiving apparatus can be simplified, which can reduce complexity and power consumption of the WU procedure.

With reference to the first aspect or the second aspect, in some embodiments, the prefix part includes one LFM signal.

According to the above technical solution, the end of the LFM signal in the first symbol of the signature part can be replicated and used as a cyclic prefix (CP) in the prefix part, which simplifies the structure of the prefix part. Thus, complexity and power consumption of the WU procedure can be reduced.

With reference to the first aspect or the second aspect, in some embodiments, the prefix part includes multiple LFM signals.

According to the above technical solution, the prefix part can include multiple LFM signals, which allows the prefix part to have a long total time duration. That is, the receiving apparatus can perform synchronization for wake-up signals with large timing offset. Thus, the reliability of the WU procedure can be increased.

With reference to the first aspect or the second aspect, in some embodiments, the multiple LFM signals includes the first LFM signal in the prefix part and at least one other LFM signal, an LFM rate of an LFM signal in the first symbol of the signature part and an LFM rate of the at least one other LFM signal are the same, a time duration of the first symbol in the signature part and a time duration of the at least one other LFM signal are the same, and an initial frequency of the LFM signal in the first symbol of the signature part and an initial frequency of the at least one other LFM signal are the same.

According to the above technical solution, the same configuration as the first symbol in the signature part is used on each LFM signal, except the first one, in the prefix part, which simplifies the structure of the prefix part. Thus, complexity and power consumption of the WU procedure can be reduced.

With reference to the first aspect or the second aspect, in some embodiments, the timing offset is obtained based on the first K samples taken from the wake-up signal, K is a positive integer greater than 1, and the K samples are in the prefix part, or the K samples are in the prefix part and the first symbol of the signature part.

According to the above technical solution, the total time duration of the prefix part and/or the value of K can be chosen for the receiving apparatus, such that the K samples which are chosen for obtaining a timing offset are in the duration of the prefix part and at most the first symbol of the signature part. That is, the receiving apparatus can obtain the timing offset based on these K samples without knowing the boundaries of the LFM signals in the prefix part. Thus, complexity and power consumption of the WU procedure can be reduced.

With reference to the first aspect or the second aspect, in some embodiments, the timing offset indicates a position of the at least one LFM signal in the signature part in a time domain.

According to the above technical solution, the receiving apparatus can separate the at least one LFM signal in the signature part based on the timing offset, which allows the receiving apparatus to apply different frequency shifts to different samples. Thus, the reliability of the WU procedure can be increased.

With reference to the first aspect or the second aspect, in some embodiments, the at least one parameter associated with at least one LFM signal in the signature part includes at least one or more of the following: an LFM rate of the at least one LFM signal in the signature part, a time duration of the at least one LFM signal in the signature part, and an initial frequency of the at least one LFM signal in the signature part.

According to the above technical solution, the receiving apparatus can determine whether to transition from the first mode to the second mode based on whether the at least one parameter is consistent with the configuration parameter of the signature part.

With reference to the first aspect, in some embodiments, the method further includes: receiving configuration information, where the configuration information indicates a configuration parameter of the prefix part, and the configuration parameter of the prefix part is used to obtain the timing offset.

With reference to the second aspect, in some embodiments, the method further includes: transmitting configuration information, where the configuration information indicates a configuration parameter of the prefix part, and the configuration parameter of the prefix part is used to obtain the timing offset.

According to the above technical solution, the transmitting apparatus can generate the prefix part of the wake-up signal based on the configuration information of the receiving apparatus, and the receiving apparatus can process the wake-up signal to obtain the timing offset based on the configuration information. Thus, the reliability of the WU procedure can be improved.

With reference to the first aspect or the second aspect, in some embodiments, the configuration parameter of the prefix part includes the number of LFM signals in the prefix part and a time duration of the first LFM signal in the prefix part.

With reference to the first aspect or the second aspect, in some embodiments, the time duration of the first LFM signal in the prefix part meets the following formula:

$${T}_{p r}^{′} = {ρ}_{1} {T}_{s}$$

$${T}_{pr}^{′}$$

is the time duration of the first LFM signal in the prefix part, Tₛ is a time duration of a symbol in the signature part, and ρ₁ is a positive number less than 1.

According to the above technical solution, the structure of the configuration information can be simplified.

With reference to the first aspect or the second aspect, in some embodiments, the configuration parameter of the prefix part includes a total time duration of the prefix part.

With reference to the first aspect or the second aspect, the total time duration of the prefix part meets the following formula:

$${T}_{pr} = ρ {T}_{s}$$

Tₚᵣ is the total time duration of the prefix part, Tₛ is a time duration of a symbol in the signature part, and ρ is a positive number equal to or greater than 1.

According to the above technical solution, the structure of the configuration information can be simplified.

With reference to the first aspect or the second aspect, in some embodiments, the configuration parameter of the prefix part includes a specifier, and the specifier indicates that the wake-up signal includes the prefix part.

According to the above technical solution, a specifier in the configuration information can indicate whether the wake-up signal includes the prefix part. That is, the prefix part can be included in the wake-up signal only when necessary. Thus, complexity and power consumption of the WU procedure can be reduced.

With reference to the first aspect or the second aspect, in some embodiments, the configuration parameter of the prefix part is associated with a cell identifier.

According to the above technical solution, one or more of apparatuses associated with the cell identifier can use the same configurations.

With reference to the first aspect or the second aspect, in some embodiments, the configuration information indicates a configuration parameter of the signature part, and the configuration parameter of the signature part includes at least one or more of the following: an LFM rate of the at least one LFM signal in the signature part, a time duration of the at least one LFM signal in the signature part, and an initial frequency of the at least one LFM signal in the signature part.

According to the above technical solution, the transmitting apparatus can generate the signature part of the wake-up signal based on the configuration information of the receiving apparatus, and the receiving apparatus can process the wake-up signal to determine whether to transition from the first mode to the second mode based on the configuration information. Thus, the reliability of the WU procedure can be improved.

With reference to the first aspect, in some embodiments, the timing offset is obtained based on the first K samples taken from the wake-up signal, K is a positive integer greater than 1, and the configuration information indicates a value of K.

According to the above technical solution, the value of K can be part of the configuration parameters sent to the receiving apparatus by the transmitting apparatus, which can make the K samples used to obtain a timing offset in the duration of the prefix part and at most the first symbol of the signature part. Thus, complexity and power consumption of the WU procedure can be reduced.

With reference to the first aspect, in some embodiments, the method further includes: transmitting feedback information in the second mode, where the feedback information indicates the timing offset, and the timing offset is used to adjust a total time duration of the prefix part.

With reference to the second aspect, in some embodiments, the method further includes: receiving feedback information, where the feedback information indicates the timing offset, and the timing offset is used to adjust a total time duration of the prefix part.

According to the above technical solution, the receiving apparatus can transmit the feedback information after transitioning into the second mode. The transmitting apparatus may adjust configurations of the wake-up signals based on the feedback information. Thus, the reliability of the WU procedure can be further improved.

With reference to the first aspect or the second aspect, in some embodiments, power consumption corresponding to the first mode is lower than power consumption corresponding to the second mode.

According to the above technical solution, for example, the first mode may be an idle mode (or state), an inactive mode (or state), or other low-power consumption modes. The second mode may be a connected mode (or state) or other modes with higher power consumption than the first mode.

According to a third aspect, a receiving apparatus is provided. The receiving apparatus includes a function or unit configured to perform the method according to the first aspect or any one of the possible embodiments of the first aspect.

For example, the receiving apparatus could be a terminal device or a chip in the terminal device. For another example, the receiving apparatus could be a network device or a chip in the network device.

According to a fourth aspect, a transmitting apparatus is provided. The transmitting apparatus includes a function or unit configured to perform the method according to the second aspect or any one of the possible embodiments of the second aspect.

For example, the transmitting apparatus could be a network device or a chip in the network device. For another example, the transmitting apparatus could be a terminal device or a chip in the terminal device.

According to a fifth aspect, a system is provided. The system includes: the receiving apparatus according to the third aspect and the transmitting apparatus according to the fourth aspect.

According to a sixth aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs the method in any one of the first aspect or the possible implementations of the first aspect, or the communication apparatus performs the method in any one of the second aspect or the possible implementations of the second aspect.

With reference to the sixth aspect, in some implementations of the sixth aspect, the communication apparatus may be a receiving apparatus. For example, the communication apparatus may be a terminal device or a component (for example, a chip or integrated circuit) installed in the terminal device. For another example, the communication apparatus may be a network device or a component (for example, a chip or integrated circuit) installed in the network device.

With reference to the sixth aspect, in some implementations of the sixth aspect, the communication apparatus may be a transmitting apparatus. For example, the communication apparatus may be a network device or a component (for example, a chip or integrated circuit) installed in the network device. For another example, the communication apparatus may be a terminal device or a component (for example, a chip or integrated circuit) installed in the terminal device.

According to a seventh aspect, a communication apparatus is provided. The communication apparatus includes a processor and a communications interface. The processor is connected to the communications interface. The processor is configured to execute one or more instructions, and the communications interface is configured to communicate with other network elements under the control of the processor. The processor is enabled to perform the method according to the first aspect or any one of the possible embodiments of the first aspect, or the second aspect or any one of the possible embodiments of the second aspect.

According to an eighth aspect, a computer storage medium is provided. The computer storage medium stores program code, and the program code is used to execute one or more instructions for the method according to the first aspect or any one of the possible embodiments of the first aspect, or the second aspect or any one of the possible embodiments of the second aspect.

According to a ninth aspect, this application provides a computer program product including one or more instructions, where when the computer program product runs on a computer, the computer performs the method according to the first aspect or any one of the possible embodiments of the first aspect, or the second aspect or any one of the possible embodiments of the second aspect.

### DESCRIPTION OF DRAWINGS

FIG. 1 is a schematic diagram of an application scenario according to this application;

FIG. 2 illustrates an example communication system 100;

FIG. 3 illustrates another example of an ED and a base station;

FIG. 4 is a schematic diagram of one LFM signal;

FIG. 5 is a schematic diagram of an example of a wake-up signal;

FIG. 6 is a schematic flowchart of a communication method 600 according to an embodiment of this application;

FIG. 7 illustrates an example of a prefix part including multiple LFM signals according to an embodiment of this application;

FIG. 8 illustrates a first example of a prefix part including a single LFM signal according to an embodiment of this application;

FIG. 9 illustrates an example of a WU procedure at a transmitting apparatus side according to an embodiment of this application;

FIG. 10 illustrates an example of a WU procedure at a receiving apparatus side according to an embodiment of this application;

FIG. 11 is a schematic block diagram of an example of a receiving apparatus according to an embodiment of this application;

FIGS. 12-16 are schematic block diagrams of possible devices according to embodiments of this application.

### DESCRIPTION OF EMBODIMENTS

The following describes technical solutions of the present application with reference to the accompanying drawings.

The technical solutions in embodiments of this application may be applied to various communication systems, such as a Global System for Mobile Communications (GSM), a Code Division Multiple Access (CDMA) system, a Wideband Code Division Multiple Access (WCDMA) system, a general packet radio service (GPRS) system, a Long Term Evolution (LTE) system, an LTE frequency division duplex (FDD) system, an LTE time division duplex (TDD) system, a Universal Mobile Telecommunications System (UMTS), a Worldwide Interoperability for Microwave Access (WiMAX) communications system, a wireless local area network (WLAN), a fifth generation (5G) wireless communications system, a new radio (NR) wireless communications system, a sixth generation (6G) wireless communications system, integrated access and backhaul (IAB) system, a mesh network, a side link system, or other evolving communication systems. The technical solutions in embodiments of this application may be applied to the communication system that integrates the above two or more systems.

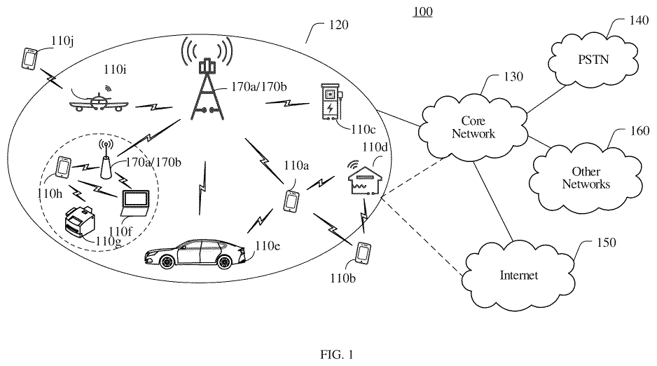

For ease of understanding the embodiments of this application, a communications system shown in FIGS. 1-3 is first used as an example to describe in detail a communications system to which the embodiments of this application are applicable.

FIG. 1 is a schematic diagram of an application scenario according to this application. Referring to FIG. 1, as an illustrative example without limitation, a simplified schematic illustration of a communication system is provided. The communication system 100 includes a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. The communication system 100 further includes a public switched telephone network (PSTN) 140, the Internet 150, and other networks 160.

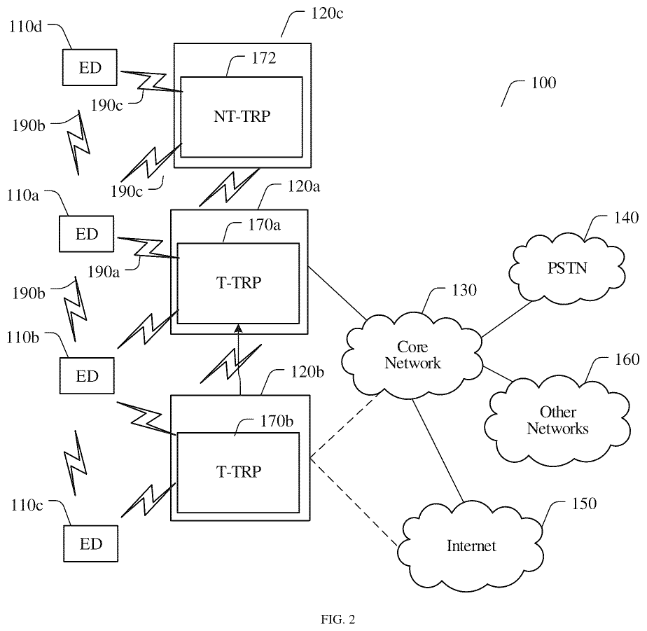

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered as sub-systems of the communication system. In the example shown, the communication system 100 includes electronic devices (ED) 110a-110d (generically referred to as ED 110), radio access networks (RANs) 120a-120b, a non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the Internet 150, the core network 130, the PSTN 140, the other networks 160, or any combination thereof. In some examples, the ED 110a may communicate an uplink and/or downlink transmission over an interface 190a with the T-TRP 170a. In some examples, the EDs 110a, 110b and 110d may also communicate directly with one another via one or more sidelink air interfaces 190b. In some examples, the ED 110d may communicate an uplink and/or downlink transmission over an interface 190c with the NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or more NT-TRPs 172 via a wireless link or simply a link. For some examples, the link is a dedicated connection for unicast transmission, a connection for broadcast transmission, or a connection between a group of EDs and one or more NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by the core network 130, and may or may not employ the same radio access technology as the RAN 120a, the RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. The PSTN 140 may include circuit switched telephone networks for providing plain old telephone service (POTS). The Internet 150 may include a network of computers and subnets (intranets) or both, and incorporate protocols, such as Internet Protocol (IP), Transmission Control Protocol (TCP), User Datagram Protocol (UDP). The EDs 110a 110b, and 110c may be multimode devices capable of operation according to multiple radio access technologies, and incorporate multiple transceivers necessary to support such.

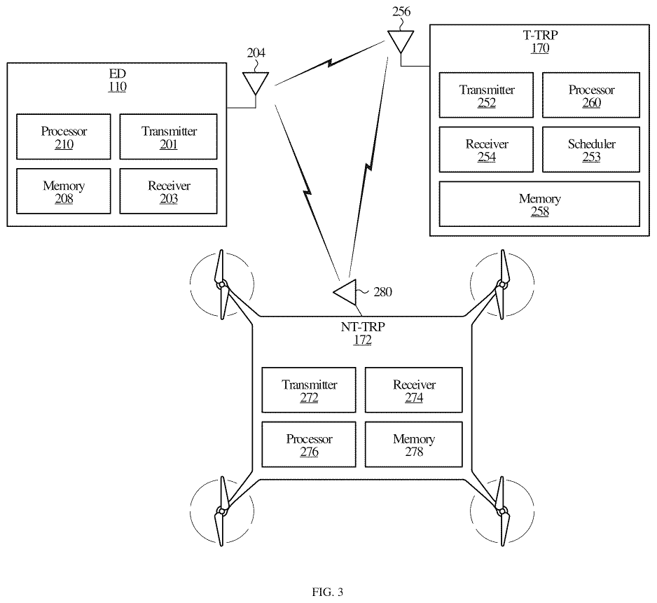

FIG. 3 illustrates another example of an ED and a base station. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronic device, a smart book, a vehicle, a car, a truck, a bus, a train, or an IOT device, an industrial device, or an apparatus (e.g. a communication module, a modem, or a chip) in the foregoing devices, among other possibilities. Future generation EDs 110 may be referred to using other terms. The base stations 170a and 170b are T-TRPs and will hereafter be referred to as T-TRP 170. Also shown in FIG. 3, an NT-TRP will hereafter be referred to as NT-TRP 172. Each ED 110 connected to the T-TRP 170 and/or the NT-TRP 172 can be dynamically or semi-statically turned-on (i.e., established, activated, or enabled), turned-off (i.e., released, deactivated, or disabled) and/or configured in response to one or more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to output or modulate data or other content for transmission by at least one antenna 204 or interface. The transceiver is further configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The transceiver may also be known as an interface, for inputting and outputting operations.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or T-TRP 170. In some embodiments, the processor 276 implements the transmit beamforming and/or receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in the memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some embodiments, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatuses (e.g. a communication module, a modem, or a chip) in the foregoing devices.

The CU (or CU-control plane (CP) and CU-user plane (UP)), DU or RU may be known by other names in some embodiments. For example, in an open RAN (ORAN) system, the CU may also be referred to as open CU (O-CU), the DU may also be referred to as open DU (O-DU), the CU-CP may also be referred to open CU-CP (O-CU-CP), the CU-UP may also be referred to as open CU-UP (O-CU-CP), and the RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as a common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some embodiments, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

Embodiments of this application can be applied to any communication scenario where one or more transmitting apparatuses communicate with one or more receiving apparatuses. In a first example, the transmitting apparatus may be a network device (e.g. T-TRP or NT-TRP) or a chip in the network device, and the receiving apparatus may be a terminal device (e.g. ED) or a chip in the terminal device. In a second example, the transmitting apparatus may be a network device or a chip in the network device, and the receiving apparatus may be another network device or a chip in the network device. In a third example, the transmitting apparatus may be a terminal device or a chip in the terminal device, and the receiving apparatus may be another terminal device or a chip in the terminal device. This is not limited in this application. The following embodiments are illustrative of one transmitting apparatus and one receiving apparatus.

For ease of understanding the embodiments of this application, the terms involved in this application are briefly explained below.

### 1. WU Procedure

The WU procedure allows a node (which is an example of the receiving apparatus) to transition from a first mode to a second mode, where power consumption of the node in the first mode is less than that of the node in the second mode. For example, a node may turn off some circuitry (that is, the node transitions into the first mode) to reduce the power consumption when the node has no data to receive from or send to other nodes. The node can turn on the circuitry (that is, the node transitions from the first mode to the second mode) when the node has data to receive from other nodes. The node in the first mode does not know that it has data to receive, and a WU procedure is necessary for the node to transition from the first mode to the second mode. The transition of the node from the first mode to the second mode can also be referred to as the node being woken up.

For example, a transmitting apparatus may transmit wake-up signals (WUS) to a receiving apparatus, to make the receiving apparatus transition from the first mode to the second mode. In some embodiments of this application, the first mode may be an idle mode (or state), an inactive mode (or state), or other low-power consumption modes. The second mode may be a connected mode (or state) or other modes with higher power consumption than the first mode.

It should be noted that, in the description of this application, “mode” and “state” can have the same meaning. This will not be repeated below.

In some embodiments of this application, the WU procedure may be a part of other procedures. For example, the receiving apparatus may receive the WUS as a part of a paging procedure; or the receiving apparatus may receive the WUS as a part of a procedure to request a sensing operation; or the receiving apparatus may receive the WUS to request a measurement; or the receiving apparatus may receive the WUS as a part of a specific non-periodic procedure.

The above WU procedure is only illustrative, and this is not limited in this application.

### 2. Wake-Up Signals (WUS)

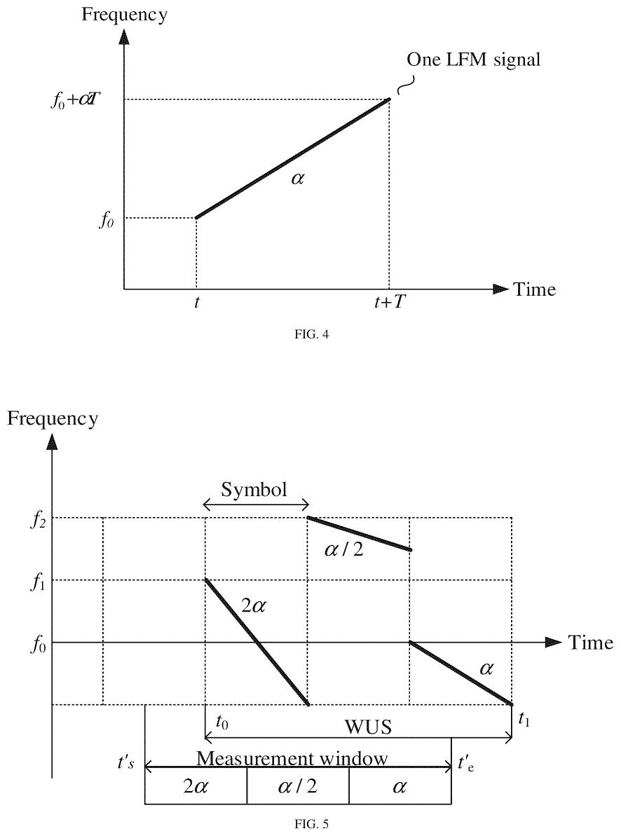

The WUS may include one or more linear frequency modulated (LFM) signals. One LFM signal is a signal whose frequency is a linear function of time with a slope. The LFM signal can be also named as a chirp signal. For ease of understanding the embodiments of this application, one LFM signal is introduced in combination with FIG. 4.

FIG. 4 is a schematic diagram of one LFM signal. As shown in FIG. 4, an initial time of the LFM signal is represented by “t,” a time duration of the LFM signal is represented by “T,” an ending time of the LFM signal is represented by “t+T,” an initial frequency (which may also be called frequency hopping) of the LFM signal is represented by “f₀,” an LFM rate of the LFM signal is represented by “a,” and an ending frequency of the LFM signal is represented by “f₀+αT”. The LFM rate of the LFM signal is the slope of the linear function. The LFM rate of the LFM signal can also be called a chirp rate or chirp slope.

One LFM signal may be indicated by one or more parameters, where the one or more parameters may be used to determine a position of the LFM signal in a time domain and a frequency domain. Based on the linear properties of the LFM signal, the one or more parameters may be a variety of parameter combinations that can determine the LFM signal. For example, the one or more parameters may be an initial time, a time duration, an initial frequency, and an LFM rate. For another example, the one or more parameters may be an initial time, an ending time, an initial frequency, and an ending frequency. This is not limited in this application.

Designing the WUS based on LFM signals can reduce the processing complexity and power consumption of the receiving apparatus compared with the WUS based on some other types of signals. For example, the receiving apparatus can process LFM signals using de-chirp processing. One LFM signal of the form

$${e}^{j 2 π ( \frac{α}{2} {t}^{2} + {f}_{0} t )}$$

is transmitted to the receiving apparatus, where a delay of a single path propagation channel between the transmitting apparatus and the receiving apparatus is represented by “τ,” and a frequency Doppler shift of the single path propagation channel is represented by “f_{D}”. Thus, the LFM signal received by the receiving apparatus may be represented by y(t)=βe^{j2πf}^{_{D}}^{t}x(t−τ)+n(t), where n(t) represents the noise signal. The de-chirp processing corresponds to multiplying the received signal y(t) by the LFM signal d(t)=e^{-jπαt}^{²}. Note that d(t) is similar to x(t) except for the sign of the LFM rate. This processing transforms the received signal y(t) into an exponential signal, where the exponent is a linear function of delay and doppler frequency shift. The operation that the receiving apparatus performs on the received signal y(t) is not limited in this application. For example, receiving apparatus may perform a fast Fourier transformation (FFT) on the received signal to estimate the exponent of the signal after de-chirp processing. After de-chirp processing, the required sampling frequency may be much smaller than the original LFM signal bandwidth (i.e., x(t)) and a low frequency sampling may be applied. Thus, the power consumption of the receiving apparatus can be reduced.

The WUS may include multiple LFM signals, and configuration information of the WUS used to wake up the receiving apparatus is known to the receiving apparatus. For example, the configuration information includes: time durations of the multiple LFM signals, LFM rates of the multiple LFM signals, and initial frequencies of the multiple LFM signals. The receiving apparatus may detect whether its corresponding WUS has been transmitted by the transmitting apparatus or not. If the receiving apparatus determines that the transmitting apparatus has sent the corresponding WUS, the receiving apparatus may transition from the first mode to the second mode. If not, the receiving apparatus may stay in the first mode. For ease of understanding the embodiments of this application, an example of WUS is introduced in combination with FIG. 5.

FIG. 5 is a schematic diagram of an example of WUS. The WUS corresponding to a receiving apparatus includes three LFM signals, which are represented by LFM signal #0, LFM signal #1, and LFM signal #2, respectively, in the following description. For the LFM signal #0, an initial frequency is represented by “f₁,” a time duration is equal to a single symbol, an LFM rate is represented by “2α,” and the initial time of the LFM signal #0 is represented by “t₀”. For the LFM signal #1, an initial frequency is represented by “f₂,” a time duration is equal to a single symbol, and an LFM rate is represented by “α/2”. For the LFM signal #2, an initial frequency is represented by “f₀” and a time duration is equal to a single symbol, and an LFM rate is represented by “α”. As shown in FIG. 5, these three LFM signals have certain initial frequencies and LFM rates on the three symbols. The receiving apparatus may perform the operations described above to obtain the initial frequencies and the LFM rates, to determine whether its corresponding WUS is transmitted or not.

As shown in FIG. 5, a receiving apparatus determines whether the corresponding WUS is transmitted during a certain period of time. This period of time may be referred to as a time window, a measurement window, a monitoring window, or the like. There is a timing offset between the transmitting apparatus and the receiving apparatus, resulting in a mismatch between the measurement window and time interval of the WUS. For example, the time interval of the WUS is from t₀ to t₁, but the measurement window is from t′₀ to t′₁. According to the way an LFM signal is processed by the receiving apparatus, the processing for each LFM signal is a function of the LFM rate, frequency, and time. Since LFM rates on two symbols may be different, it is important for the receiving apparatus to know the position of each LFM signal in a time domain. The processing of the receiving apparatus does not match the position of the WUS in the time domain, which can result in a false alarm or misdetection of a WU event.

The timing offset may represent both a synchronization timing offset and a time of flight. The synchronization timing offset is the difference between the clock of the receiving apparatus (may be also referred to as the local clock) and the clock of the transmitting apparatus (may be also referred to as the network clock). The time of flight, which may be referred to as a delay or a propagation delay, is the time it takes for the WUS to propagate the path from the transmitting apparatus to the receiving apparatus. Mathematically, there is T_{off}=T_{syn}+ToF, where T_{off} is the timing offset, T_{syn} is the synchronization timing offset, and ToF is the time of flight.

Performing synchronization before the processing of the WU may improve the reliability of the WU procedure. However, using an additional signal to perform synchronization may increase the complexity and power consumption of the WU procedure. Therefore, how to reduce the complexity and power consumption of the WU procedure becomes an urgent problem to be solved.

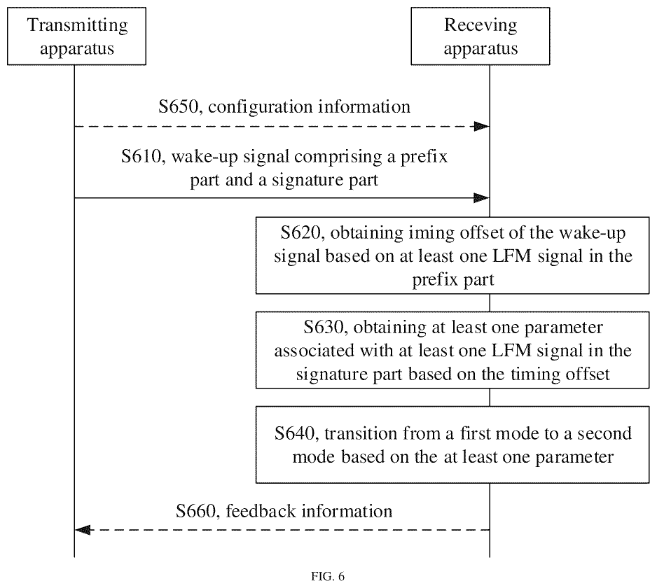

Therefore, this application provides a communication method in which the wake-up signals include a prefix part and a signature part, where the prefix part includes at least one LFM signal and the signature part includes at least one LFM signal. The receiving apparatus may process the whole wake-up signal (including the prefix part and the signature part) in a same way, and can obtain a timing offset to perform the rest of the WU procedure. In other word, the synchronization can be performed as a part of the WU procedure in a simple and low consumption way. Thus, complexity and power consumption of the WU procedure can be reduced. In the following, the communication method provided in this application will be described in combination with FIG. 6.

FIG. 6 is a schematic flowchart of a communication method 600 according to an embodiment of this application. The communication method 600 may be applied to the communications system described above.

At S610, the transmitting apparatus transmits a wake-up signal. Correspondingly, the receiving apparatus, in a first mode, receives the wake-up signal.

The wake-up signal (WUS) includes a prefix part and a signature part. The prefix part includes at least one LFM signal and the signature part includes at least one LFM signal. At least one parameter associated with the at least one LFM signal in the signature part can be obtained based on a timing offset obtained from the at least one LFM signal in the prefix part. That is, the receiving apparatus can process the whole wake-up signal (including the prefix part and the signature part) in a same way, and can obtain a timing offset to perform the rest of the WU procedure. In other word, the synchronization can be performed as a part of the WU procedure in a simple and low consumption way. Thus, complexity and power consumption of the WU procedure can be reduced.

In the description of this application, “generating A based on B” and “generating A at least based on B” can have the same meaning. The phrases “determining A based on B” and “determining A at least based on B” also can have a same meaning. This will not be repeated below.

In some embodiments of this application, a position of a signal in a time domain may be referred to as a time interval when the receiving apparatus receives (or detects) this signal. The receiving apparatus knows the position of this signal in the time domain, that is, the receiving apparatus may know the initial time and ending time of this signal.

The receiving apparatus may detect the WUS in a measurement window. The initial time of the measurement window and the initial time of the WUS may be not the same. That is, there may be a timing offset between the initial time of the measurement window and the initial time of the WUS. This may result in the receiving apparatus not capturing all the WUS. Therefore, the receiving apparatus receiving the WUS includes: receiving the whole WUS or receiving part of the WUS (at least including part of the prefix part and part of the signature part). It should be noted that parts of the prefix part can also be used to perform synchronization, and parts of the prefix part can also be used to perform the rest of the WU procedure.

The measurement window can be configured in a variety of ways. In some embodiments, the measurement window interval can be specified for the receiving apparatus by the transmitting apparatus. For example, the measurement window interval can be a part of the WUS configuration sent to the receiving apparatus by the transmitting apparatus. In some other embodiments, the measurement window interval can be predefined (for example, predefined in a standard). It is not limited in this application.

In some embodiments, the receiving apparatus can periodically measure WUS when the receiving apparatus is in a first mode. That is, the measurement window may appear periodically, and the receiving apparatus enters the first mode (which is a low power mode) and periodically monitor whether its associated WUS has been transmitted by the transmitting apparatus or not.

The prefix part can be transmitted based on one or more configuration parameters of the prefix part by the transmitting apparatus. In some embodiments, the configuration parameter(s) of the prefix part can be a part of the WUS configuration indicated by configuration information, which is sent to the receiving apparatus by the transmitting apparatus. The prefix part of the WUS can be configured by the configuration parameter(s) of the prefix part in a variety of ways.

For example, the configuration parameters of the prefix part may include the number of LFM signals in the prefix part (denoted by L) and a time duration of the first LFM signal in the prefix part (denoted by

$${T}_{pr}^{′} ) .$$

In some embodiments, the time duration of the first LFM signal in the prefix part can be expressed as

$${T}_{pr}^{′} = {ρ}_{1} {T}_{s} ,$$

where

$${T}_{pr}^{′}$$

is the time duration of the first LFM signal in the prefix part, Tₛ is the time duration of a symbol in the signature part, and ρ₁ is a positive number less than 1. In some embodiments, ρ₁ can be expressed as ρ₁=2^{-N}^{₁}, where N₁ is a positive integer.

In some embodiments, LFM signals except the first LFM signal in the prefix part may have the same time duration and the configuration parameters of the prefix part may further include the same time duration of other LFM signals in the prefix part. For example, the same time duration of other LFM signals in the prefix part may be equal to the time duration of one or more symbols in the signature part. In other word, the same time duration of other LFM signals in the prefix part may be an integer multiple of Tₛ.

For another example, the configuration parameter of the prefix part may include a total time duration of the prefix part (denoted by Tₚᵣ). In some embodiments, the total time duration of the prefix part can be expressed as Tₚᵣ=ρTₛ, where Tₚᵣ is the total time duration of the prefix part, Tₛ is a time duration of a symbol in the signature part, and ρ is a positive number equal to or greater than 1. In some embodiments, ρ can be expressed as a summation of an integer value and a value less than 1, and there are three examples to express:

In a first example, ρ can be expressed as ρ=2^{N}, where N is a positive integer.

In a second example, ρ can be expressed as ρ=2^{-M}, where M is a positive integer.

In a third example, ρ can be expressed as ρ=2^{N}+2^{-M}, where N and M are positive integers.

The signature part can be transmitted based on one or more configuration parameters of the signature part by the transmitting apparatus. In some embodiments, the configuration parameter(s) of the signature part also can be a part of the WUS configuration indicated by the configuration information.

In some embodiments, the signature part can include multiple time units in the time domain where each of which includes one single LFM signal among the at least one LFM signal in the signature part. That is, the initial time of one LFM signal in the signature part is the initial time of one time unit in the signature part and the time duration of the LFM signal is the time duration of the time unit. In some embodiments, the time unit is, but not limited to, a symbol, an orthogonal frequency division multiplexing (OFDM) symbol, and a slot. For ease of description, “symbol” is used as an example of “time unit” in this description but does not limit the scope of protection of the embodiments of this application, and this will not be repeated below.

For example, the configuration parameters of the signature part may include at least one or more of the following: a number of symbols in the signature part denoted by N_{sig}, where each of which includes one LFM signal; a sequence of LFM rates denoted by (α₁, α₂, . . . , α_{N}_{_{sig}}), where αᵢ is an LFM rate of the LFM signal in the i-th symbol of the signature part; a sequence of time durations denoted by (T₁, T₂, . . . , T_{N}_{_{sig}}), where Tᵢ is a time duration of the LFM signal in the i-th symbol of the signature part; a sequence of initial frequencies denoted by (f₁, f₂, . . . , f_{N}_{_{sig}}), where fᵢ is an initial frequency of the LFM signal in the i-th symbol of the signature part.

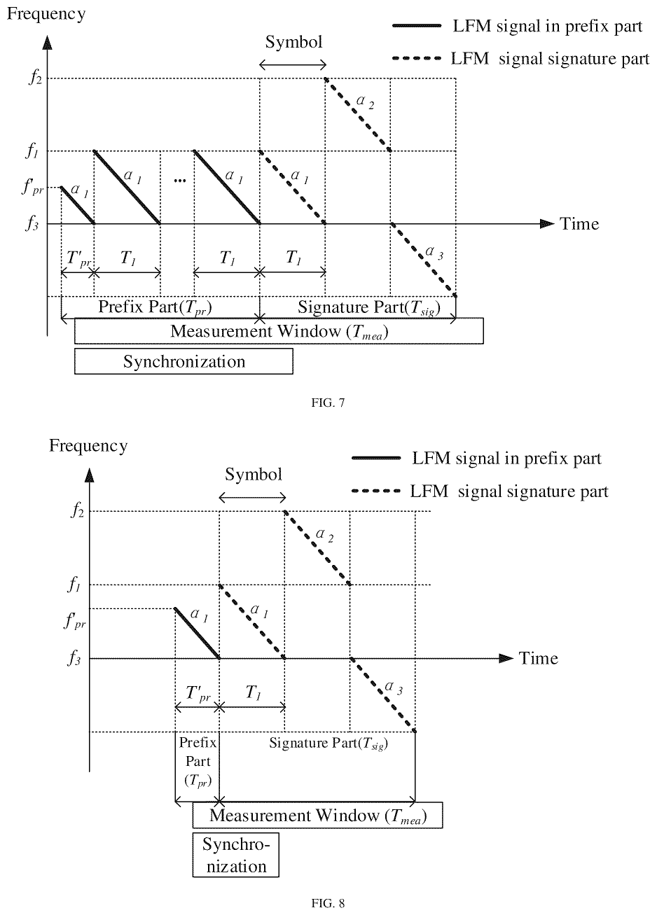

In some embodiments, the prefix part may include multiple LFM signals. Optionally, the multiple LFM signals except the first LFM signal in the prefix part may be replicas of the LFM signal in the first symbol of the signature part, and the first LFM signal in the prefix part may be a replica of end part of the LFM signal in the first symbol of the signature part. For ease of understanding the embodiments of this application, an embodiment is illustrated in combination with FIG. 7.

As shown in FIG. 7, the multiple LFM signals in the prefix part may include the first LFM signal in the prefix part and at least one other LFM signal. LFM rates of all the multiple LFM signals in the prefix part and the LFM rate of the LFM signal in the first symbol of the signature part are the same (denoted by α₁). The time duration of the at least one other LFM signal and the time duration of the first symbol in the signature part are the same (denoted by T₁). It should be understood that T₁ can be an example of aforementioned Tₛ (a time duration of a symbol in the signature part). The initial frequency of the at least one other LFM signal and the initial frequency of the LFM signal in the first symbol of the signature part are the same (denoted by f₁).

It can be seen from FIG. 7, the initial frequency of the first LFM signal in the prefix part can be expressed as

$${f}_{pr}^{′} = {f}_{1} + {α}_{1} ( {T}_{1} - {T}_{pr}^{′} ) ,$$

where

$${f}_{pr}^{′}$$

is the initial frequency of the first LFM signal in the prefix part. f₁ is an initial frequency of an LFM signal in the first symbol of the signature part. α₁ is an LFM rate of the LFM signal in the first symbol of the signature part. T₁ is a time duration of the first symbol in the signature part.

$${T}_{pr}^{′}$$

is a time duration of the first LFM signal in the prefix part, and

$${T}_{pr}^{′}$$

is less than or equal to T₁.

Having the above configurations for the prefix part may provide the following benefits:

First, the same configuration as the first symbol in the signature part is used on each LFM signal, except the first one, in the prefix part, which simplifies the structure of the prefix part. Thus, the prefix detection procedure can be simplified so that complexity and power consumption of the WU procedure can be reduced.

Second, the phase is continuous between the multiple LFM signals in the prefix part and the LFM signal in the first symbol of the signature part. Thus, the synchronization can be performed using the prefix part and the first symbol of the signature part so that complexity and power consumption of the WU procedure can be reduced.

Third, the aforementioned structure of WUS allows the receiving apparatus to receive the whole WUS (including the prefix part and the signature part). The whole WUS can be processed and sampled to obtain the timing offset from the measurement window, and then the symbol boundaries can be obtained based on the timing offset to perform the rest of the WU procedure. The processing and sampling of WUS will be illustrated specifically in following embodiments, so it is not be repeated here.

In addition, a total time duration of the prefix part can be expressed as

$${T}_{p r} = {T}_{pr}^{′} + ( L - 1 ) {T}_{1} .$$

Thus, the prefix part includes multiple LFM signals, which allows the prefix part to have a long total time duration. That is, the receiving apparatus can perform synchronization for wake-up signals with large timing offset. Thus, the reliability of the WU procedure can be increased.

In some other embodiments, the prefix part may include one single LFM signal (that is L=1). Optionally, the single LFM signal in the prefix part may be a replica of the end part of the LFM signal in the first symbol of the signature part. As shown in FIG. 8, the LFM rates of the single LFM signal in the prefix part and the LFM rate of the LFM signal in the first symbol of the signature part are the same (denoted by α₁). The initial frequency of the single LFM signal in the prefix part can be expressed as

$${f}_{pr}^{′} = {f}_{1} + {α}_{1} ( {T}_{1} - {T}_{pr}^{′} ) ,$$

where

$${f}_{pr}^{′}$$

is the initial frequency of the single LFM signal in the prefix part. f₁ is an initial frequency of the LFM signal in the first symbol of the signature part. α₁ is an LFM rate of the LFM signal in the first symbol of the signature part. T₁ is a time duration of the first symbol in the signature part.

$${T}_{pr}^{′}$$

is a time duration of the single LFM signal in the prefix part, and

$${T}_{pr}^{′}$$

is less than or equal to T₁. The way

$${f}_{pr}^{′}$$

is computed is equivalent to replicating the end of the LFM signal in the first symbol of the signature part and using it as the prefix. In some embodiments, this single LFM signal may be referred to as a cyclic prefix.

In this case, the phase is continuous between the first LFM signal in the prefix part and the LFM signal in the first symbol of the signature part. Thus, the synchronization can be performed using the prefix part and the first symbol of the signature part so that complexity and power consumption of the WU procedure can be reduced. In addition, the structure of the prefix part can be simplified.

In some embodiments, the WUS configuration (including a configuration parameter of the prefix part and/or a configuration parameter of the signature part) has an association relationship with one or more of the following: a cell identifier and a group identifier. For example, the WUS configurations have an association with the cell identifier, and apparatuses associated with the cell identifier can share the same WUS configurations. For another example, the WUS configurations have an association relationship with the group identifier, and apparatuses belonging to the group share the same WUS configurations. This is not limited in this application.

In some other embodiments, the WUS configuration may also have an association relationship with an identifier of the receiving apparatus.

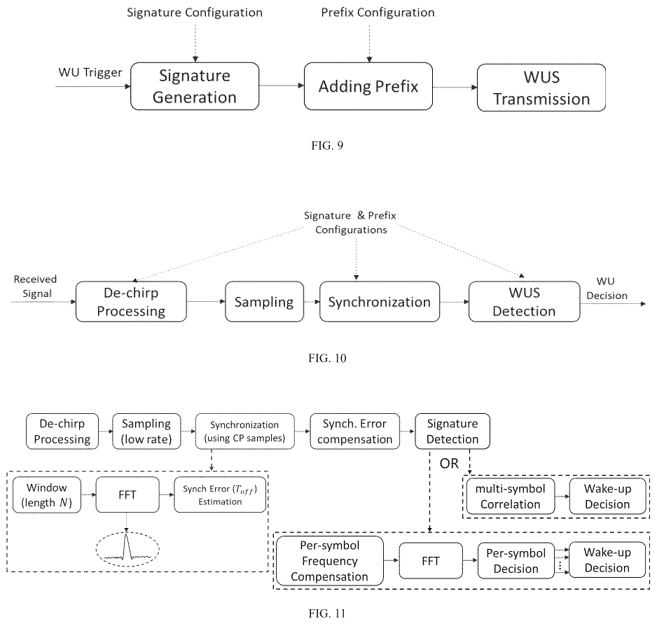

FIG. 9 illustrates an example of a WU procedure at a transmitting apparatus side. As shown in FIG. 9, whenever there is a trigger for WU, the signature part is generated based on the configuration parameter of the signature part of the receiving apparatus which is to be woken up. The prefix part is generated based on the configuration parameter of the prefix part of the receiving apparatus which is to be woken up. Then, the prefix part is added to the signature part to generate the WUS, and the WUS is transmitted.

At S620, the receiving apparatus obtains a timing offset of the wake-up signal based on at least one LFM signal in the prefix part.

At S630, the receiving apparatus obtains at least one parameter associated with at least one LFM signal in the signature part based on the timing offset.

In some embodiments, the timing offset indicates the position of the at least one LFM signal in the signature part in a time domain. For example, the initial time of an LFM signal in the prefix part is configured as to, and the initial time of the LFM signal on the receiving side is determined to be

$${t}_{0}^{′} .$$

The receiving apparatus can obtain an estimate of the timing offset (denoted by \hat{T}_{off}). For example,

$${\hat{T}}_{off} = {t}_{0}^{′} - {t}_{0} .$$

Thus, the receiving arratus may know which part of the signal captured in the measurement window is the signature part. If the time duration of one symbol is known to the receiving apparatus, the receiving apparatus also may obtain the boundaries of symbols in this progress.

In some embodiments, the timing offset is obtained based on the first K samples taken from the wake-up signal, and K is a positive integer greater than 1. FIG. 10 illustrates an example of a WU procedure at a receiving apparatus side. As shown in FIG. 10, the receiving apparatus may process the signal received in the measurement window through de-chirp processing and sampling. Because of de-chirp processing, the sampling rate of the receiving apparatus can be reduced. This in turn reduces the power consumption specially at high frequencies where sampling is more power consuming. After sampling, multiple samples may be used to estimate the timing offset. Subsequently, the modifications based on the estimated timing offset are applied to all the samples. Finally, the compensated samples (i.e., samples after modifications) are used to perform WUS detection. If the receiving apparatus detects a signal that matches its own WUS configuration, the receiving apparatus determines to transition from a first mode to a second mode, that is, the receiving apparatus determines to wake up. Otherwise, the receiving apparatus stays in the first mode (a low power consumption mode).

For ease of description, the signal received in the measurement window can be referred to as a captured signal in this application. The receiving apparatus may process the captured signals in a variety of ways. For ease of understanding of this application, an example of processing units in the receiving apparatus is given in FIG. 11.

For example, FIG. 11 is a schematic block diagram of an example of a receiving apparatus according to an embodiment of this application. The LFM rates are fixed over all individual LFM signals belonging to the whole WUS (including the prefix part and the signature part), where a denotes the LFM rate. That is, the LMF rate of the prefix part is the same as not only the LMF rate of the LMF signal in the first symbol of the signature part, but also the LMF rates of all LMF signals in the signature part. Considering the same and fixed LFM rates for the WUS enables using one de-chirp processing unit which reduces the hardware and operational complexities.

After de-chirp processing, the receiving apparatus takes samples from the captured signal, over a given measurement window. In some embodiments, the measurement window interval can be specified for the receiving apparatus by the transmitting apparatus. For example, the measurement window interval can be a part of the WUS configuration sent to the receiving apparatus by the transmitting apparatus. For ease of description, the number of the samples taken from the captured signal is denoted by N, and N is a positive integer greater than 1. After taking the N samples over the entire measurement window, the receiving apparatus can use the first K samples among the N samples to obtain an estimate of the timing offset (denoted by \hat{T}_{off}). In some embodiments, the value of K can also be specified for the receiving apparatus by the transmitting apparatus. For example, the value of K can be a part of the WUS configuration sent to the receiving apparatus by the transmitting apparatus.

The receiving apparatus may obtain the estimate of the timing offset \hat{T}_{off} based on the first K samples in a variety of ways. For example, the receiving apparatus may perform a fast Fourier transformation (FFT) and/or an inverse fast Fourier transformation (IFFT) on the first K samples. For another example, the receiving apparatus may perform numerical optimization algorithms to further improve the estimation accuracy.

After finding the estimate of the timing offset \hat{T}_{off}, the receiving apparatus may apply phase shift (denoted by exp(j2πα\hat{T}_{off}tᵢ)) to compensate the impact of the timing offset on the N samples, where tᵢ is the sampling time of the i-th sample among the N samples. Another advantage of obtaining \hat{T}_{off} is that the receiving apparatus can find the symbol boundaries in the signature part as well as the boundaries between LFM signals in the prefix part. Knowing the symbol boundaries, the receiving apparatus can apply the appropriate frequency shift to the N samples based on the initial frequencies of LFM signals in the prefix part and the signature part. Subsequently, the receiving apparatus can process the compensated samples to decide if a signal that matches its own WUS configuration is present or not. If a signal that matches its own WUS configuration is detected, then the receiving apparatus can decide to wake up. Otherwise, the receiving apparatus stays in the first mode (a low power consumption mode) or even decide to change from the first mode to another low power consumption mode.

In some embodiments, the total time duration of the prefix part can be chosen for the receiver such that the K samples, which are chosen for obtaining the estimate of the timing offset, fall into the interval of the prefix part and at most the first symbol of the signature part. For example, the K samples are in the prefix part, or the K samples are in the prefix part and the first symbol of the signature part. That is, the receiving apparatus can obtain the timing offset based on these K samples without knowing the boundaries of the LFM signals in the prefix. Thus, complexity and power consumption of the WU procedure can be reduced.

In some embodiments, the total time duration of the prefix is optimized and/or configured based on the statistics of the timing offset. The statistics may be obtained from previous WU procedures and/or from the time spent since the last occasion the receiving apparatus had been synched with the transmitting apparatus. For example, each time the receiving apparatus is woken up, the timing offset may be estimated by the transmitting apparatus. In some embodiments, if the receiving apparatus sends the timing offset to the transmitting apparatus when it enters into the second mode (for example, a connected mode), the transmitting apparatus may collect these timing offsets and extract the statistics that may be used to determine the total time duration of the prefix part for this receiving apparatus in the following communication. In these embodiments, the random property of the timing offset is considered, the appropriate total duration time of the prefix part is determined and performance of the synchronization is improved.

In some embodiments, the total time duration of the prefix part and the number of the samples chosen for timing offset estimation (i.e., K) can be jointly optimized. The network can optimize these values in a receiving apparatus specific fashion based on the statistics obtained from previous timing offset estimation for the receiving apparatus.

In some embodiments, after applying frequency shifts based on the initial frequencies of LFM signals in the prefix part and the signature part, the receiver can further refine the estimate of the timing offset using an iterative approach and then, perform WUS detection.

At S640, the receiving apparatus transitions from the first mode to the second mode based on the at least one parameter associated with the at least one LFM signal in the signature part.

The receiving apparatus may determine whether the captured signal includes its corresponding signature part based on the at least one parameter associated with the at least one LFM signal in the signature part (e.g. the above sequences or parameters). For example, if the at least one parameter matches the configuration parameter(s) of the signature part indicated by the configuration information, the receiving apparatus may determine to transition from a first mode to a second mode, that is, the receiving apparatus may determine to wake up. If parameters of the captured signal do not match the configuration parameter(s) of the signature part, the receiving apparatus determines to stay in the first mode, that is, the receiving apparatus may determine not to wake up.

In some embodiments, before S610, the transmitting apparatus may indicate the receiving apparatus about the configurations of the WUS. That is, the transmitting apparatus and the receiving apparatus may perform the following at S650.

Optionally, at S650, the transmitting apparatus transmits configuration information to the receiving apparatus. Correspondingly, the receiving apparatus receives the configuration information from the transmitting apparatus.

The configuration information may indicate configurations of the WUS corresponding to the receiving apparatus. The configurations of the WUS may include one or more configuration parameters of the prefix part. For example, the configuration parameters of the prefix part may include the number of LFM signals in the prefix part and the time duration of the first LFM signal in the prefix part. For another example, the configuration parameter of the prefix part may include the total time duration of the prefix part.

In some embodiments, the configuration parameter of the prefix part may include a specifier, and the specifier indicates whether a prefix part is included in the WUS. For example, when the value of the specifier is set to 1, it means the prefix part is embedded before the signature part in the WUS, and when the value of the specifier is set to 0, it means the prefix part is not included in the WUS signal. That is, the prefix part can be included in the wake-up signal only when necessary. Thus, complexity and power consumption of the WU procedure can be reduced.

In some embodiments, the transmitting apparatus can transmit the configuration information before the receiving apparatus enters into a first mode (a low power consumption mode). For example, the receiving apparatus can receive the configuration information in a third mode. The third mode may be a connected mode (state) or other modes with higher power consumption than the first mode. In some embodiments, the third mode and the second mode can be the same.

In some embodiments, the configurations of the WUS indicated by the configuration information may also include one or more configuration parameters of the signature part. For example, the configuration parameters of the signature part may include at least one or more of the following: the number of symbols in the signature part denoted by N_{sig}, where each of which includes one LFM signal; a sequence of LFM rates denoted by (α₁, α₂, . . . , α_{N}_{_{sig}}), where αᵢ is an LFM rate of the LFM signal in the i-th symbol of the signature part; a sequence of time durations denoted by (T₁, T₂, . . . , T_{N}_{_{sig}}), where Tᵢ is a time duration of the LFM signal in the i-th symbol of the signature part; and a sequence of initial frequencies denoted by (f₁, f₂, . . . , f_{N}_{_{sig}}), where fᵢ is an initial frequency of the LFM signal in the i-th symbol of the signature part.

In some embodiments, the configurations of the WUS indicated by the configuration information may also include the measurement window interval.

In some embodiments, the configurations of the WUS indicated by the configuration information may also include the number of the samples chosen for timing offset estimation (i.e., the value of K).

In some embodiments, the configuration information can be carried in RRC or MAC-CE. For example, the transmitting apparatus may transmit the information using RRC or MAC-CE signaling procedures.

In some embodiments, after S640, if the receiving apparatus determines to wake up, the receiving apparatus may transmit feedback information. That is, the transmitting apparatus and the receiving apparatus may perform the following at S660.

Optionally, at S660, the receiving apparatus transmits feedback information to the transmitting apparatus. Correspondingly, the transmitting apparatus receives the feedback information from the receiving apparatus.

The feedback information may indicate that the receiving apparatus transitions into a second mode. For example, the receiving apparatus determines to wake up at S630, and transmits the feedback information to the transmitting apparatus after transitioning from the first mode to the second mode (e.g. exiting a low power mode and entering a connected mode).

In some embodiments, the feedback information indicates the estimate of the timing offset \hat{T}_{off}. The transmitting apparatus may feed back the timing offset estimated based on the first K samples taken from the WUS to the transmitting apparatus. Thus, the transmitting apparatus may adjust the total time duration of the prefix part and/or the value of K based on the timing offset of the feedback. For example, the transmitting apparatus may collect the instances of the estimated timing offset and use the statistics of them in order to optimize the total time duration of the prefix part and/or the value of K. This is not limited in this application.

In this application, a prefix part before the signature part is included in the wake-up signal, and at least one parameter associated with at least one LFM signal in the signature part can be obtained based on a timing offset obtained from at least one LFM signal in the prefix part. That is, the receiving apparatus can process the whole wake-up signal (including the prefix part and the signature part) in a same way, and can obtain a timing offset to perform the rest of the WU procedure. In other word, the synchronization can be performed as a part of the WU procedure in a simple and low consumption way. Thus, complexity and power consumption of the WU procedure can be reduced.

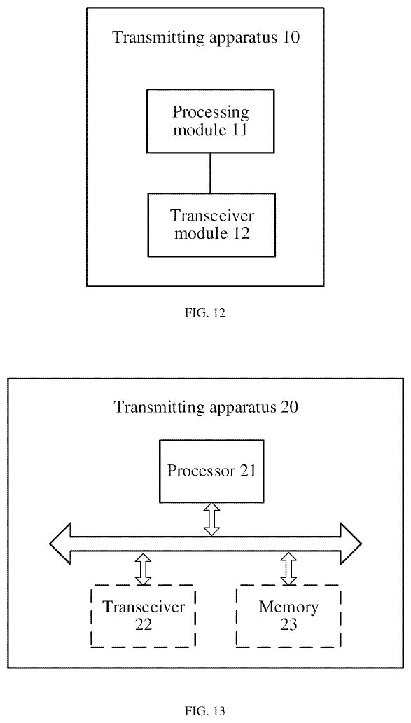

The communication method according to the embodiments of this application is described in detail above with reference to FIG. 6 to FIG. 11, and the transmitting apparatus and the receiving apparatus according to the embodiments of this application will be described in detail below with reference to FIG. 12 to FIG. 16.

FIG. 12 is a schematic block diagram of a transmitting apparatus 10 according to an embodiment of this application. As shown in FIG. 12, the transmitting apparatus 10 includes:
a processing module 11, configured to generate a wake-up signal; and
a transceiver module 12, configured to transmit the wake-up signal including a prefix part and a signature part, where the prefix part includes at least one linear frequency modulated (LFM) signal, the signature part includes at least one LFM signal, at least one parameter associated with the at least one LFM signal in the signature part is obtained based on a timing offset of the wake-up signal, the timing offset being obtained from the at least one LFM signal in the prefix part, and the at least one parameter is used for a receiving apparatus to transition from a first mode to a second mode.

Therefore, the whole wake-up signal (including the prefix part and the signature part) can be processed in a same way, and can obtain a timing offset to perform the rest of the WU procedure. In other word, the synchronization can be performed as a part of the WU procedure in a simple and low consumption way. Thus, complexity and power consumption of the WU procedure can be reduced.

The transmitting apparatus 10 in this embodiment of this application may correspond to the transmitting apparatus in the communication method in the embodiments of this application described above, and the foregoing management operations and/or functions and other management operations and/or functions of modules of the transmitting apparatus 10 are intended to implement corresponding steps of the foregoing methods. For brevity, details are not described herein again.

The transceiver module 12 in this embodiment of this application may be implemented by a transceiver, and the processing module 11 may be implemented by a processor.

As shown in FIG. 13, a transmitting apparatus 20 may include a transceiver 21.

Optionally, the transmitting apparatus 20 may further include a processor 22 and/or a memory 23. The memory 23 may be configured to store indication information, or may be configured to store code, instructions, and the like that is to be executed by the processor 22.

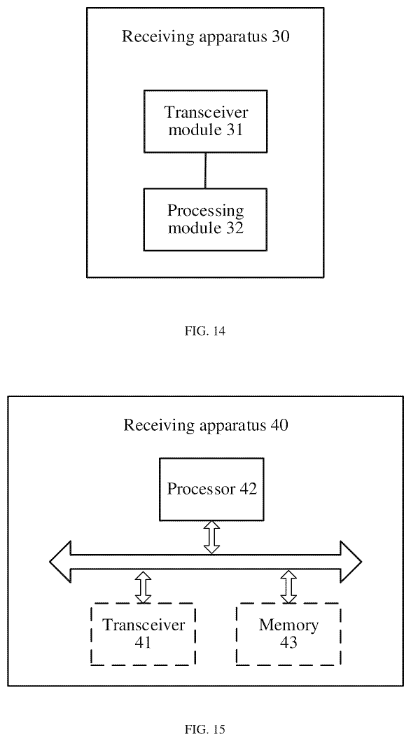

FIG. 14 is a schematic block diagram of a receiving apparatus 30 according to an embodiment of this application. As shown in FIG. 14, the receiving apparatus 30 includes:
a transceiver module 31, configured to receive, in a first mode, a wake-up signal including a prefix part and a signature part, where the prefix part includes at least one linear frequency modulated (LFM) signal and the signature part includes at least one LFM signal; and
a processing module 32, configured to obtain at least one parameter associated with the at least one LFM signal in the signature part based on a timing offset of the wake-up signal, where the timing offset is obtained from the at least one LFM signal in the prefix part; and the processing module 32 also being configured to transition from the first mode to a second mode based on the at least one parameter.

The receiving apparatus 30 in this embodiment of this application may correspond to the receiving apparatus in the communication method in the embodiments of this application described above, and the management operations and/or functions and other management operations and/or functions of modules of the receiving apparatus 30 are intended to implement corresponding steps of the foregoing methods. For brevity, details are not described herein again.

The transceiver module 31 in this embodiment of this application may be implemented by a transceiver, and the processing module 32 may be implemented by a processor.

As shown in FIG. 15, a receiving apparatus 40 may include a transceiver 41. Optionally, the receiving apparatus 40 may further include a processor 42 and/or a memory 43. The memory 43 may be configured to store indication information, or may be configured to store code, instructions, and the like that is to be executed by the processor 42.

The processor 22 or the processor 42 may be an integrated circuit chip and have a signal processing capability. In an embodiment process, steps in the foregoing method embodiments can be implemented by using a hardware-integrated logical circuit in the processor, or by using instructions in the form of software. The processing module 21 may be a general-purpose processor, a digital signal processor (Digital Signal Processor, DSP), an application-specific integrated circuit (Application Specific Integrated Circuit, ASIC), a field programmable gate array (Field Programmable Gate Array, FPGA), or another programmable logic device, a discrete gate or a transistor logic device, or a discrete hardware component. All methods, steps, and logical block diagrams disclosed in these embodiments of the present application may be implemented or performed. The general-purpose processor may be a microprocessor, or the processor may be any conventional processor or the like. Steps of the methods disclosed in the embodiments of the present invention may be directly performed and completed by a hardware decoding processor, or may be performed and completed by using a combination of hardware and software modules in the decoding processor. The software module may be located in a storage medium known in the art, such as a random access memory, a flash memory, a read-only memory, a programmable read-only memory, an electrically erasable programmable memory, or a register. The storage medium is located in the memory, and the processor reads the information in the memory and completes the steps in the foregoing methods in combination with the hardware of the processor.

The memory 23 or the memory 43 in the embodiments of the present invention may be a volatile memory or a non-volatile memory, or may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and be used as an external cache. Through example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synch Link DRAM, SLDRAM), and a direct rambus dynamic random access memory (Direct Rambus RAM, DR RAM). The storage of the system and the method described in this specification aim to include, but are not limited to, these and any other proper storage.

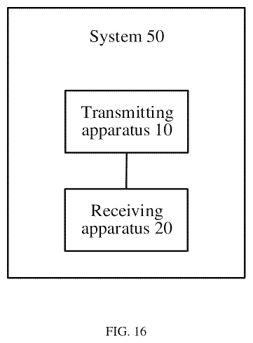

An embodiment of this application further provides a system. As shown in FIG. 16, a system 50 includes:
the transmitting apparatus 10 according to the embodiments of this application and the receiving apparatus 20 according to the embodiments of this application.

An embodiment of this application further provides a computer storage medium, and the computer storage medium may store a program instruction for executing any of the foregoing methods.

Optionally, the storage medium may be specifically the memory 23 or 43.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of this application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in this application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented by using some communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit, or may be distributed among a plurality of network units. Some or all of the units may be selected based on actual requirements to achieve the objectives of the embodiments.

In addition, function units in the embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of this application may be implemented in the form of a software product. The software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a read-only memory (Read-Only Memory, ROM), a random access memory (Random Access Memory, RAM), a magnetic disk, an optical disc or the like.

The foregoing descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method comprising:
receiving, in a first mode, a wake-up signal comprising a prefix part and a signature part, wherein the prefix part comprises first at least one linear frequency modulated (LFM) signal, and the signature part comprises second at least one LFM signal;
obtaining a timing offset of the wake-up signal based on the first at least one LFM signal in the prefix part;
obtaining at least one parameter associated with the second at least one LFM signal in the signature part based on the timing offset; and
transitioning from the first mode to a second mode based on the at least one parameter.

2. The method of claim 1, wherein the signature part comprises at least one symbol, and each symbol of the at least one symbol comprises a corresponding LFM signal among the second at least one LFM signal in the signature part.

3. The method of claim 2, wherein an LFM rate of a first LFM signal in the prefix part and an LFM rate of an LFM signal in a first symbol of the signature part are the same, and an initial frequency of the first LFM signal in the prefix part meets:
$${f}_{pr}^{′} = {f}_{1} + {α}_{1} ( {T}_{1} - {T}_{pr}^{′} )$$
wherein
$${f}_{pr}^{′}$$
is the initial frequency or the first LFM signal in the prefix part, f₁ is an initial frequency of an LFM signal in the first symbol of the signature part, α₁ is the LFM rate of the LFM signal in the first symbol of the signature part, T₁ is a time duration of the first symbol in the signature part,
$${T}_{pr}^{′}$$
is a time duration of the first LFM signal in the prefix part, and
$${T}_{pr}^{′}$$
is less than or equal to T₁.

4. The method of claim 1, wherein the prefix part comprises one LFM signal.

5. The method of claim 1, wherein the prefix part comprises multiple LFM signals.

6. The method of claim 5, wherein the multiple LFM signals comprise a first LFM signal in the prefix part and at least one other LFM signal, an LFM rate of an LFM signal in a first symbol of the signature part and an LFM rate of the at least one other LFM signal are the same, a time duration of the first symbol in the signature part and a time duration of the at least one other LFM signal are the same, and an initial frequency of the LFM signal in the first symbol of the signature part and an initial frequency of the at least one other LFM signal are the same.

7. The method of claim 1, wherein:
the timing offset is obtained based on first K samples taken from the wake-up signal, K is a positive integer greater than 1, and
the first K samples are in the prefix part, or the first K samples are in the prefix part and a first symbol of the signature part.

8. An apparatus comprising:
at least one processor; and
a memory coupled to the at least one processor, the memory for storing instructions that, when executed by the at least one processor, cause the apparatus to:
receive, in a first mode, a wake-up signal comprising a prefix part and a signature part, wherein the prefix part comprises first at least one linear frequency modulated (LFM) signal, and the signature part comprises second at least one LFM signal;
obtain a timing offset of the wake-up signal based on the first at least one LFM signal in the prefix part;
obtain at least one parameter associated with the second at least one LFM signal in the signature part based on the timing offset; and
transition from the first mode to a second mode based on the at least one parameter.

9. The apparatus of claim 8, wherein the signature part comprises at least one symbol, and each symbol of the at least one symbol comprises a corresponding LFM signal among the second at least one LFM signal in the signature part.

10. The apparatus according to claim 9, wherein an LFM rate of a first LFM signal in the prefix part and an LFM rate of an LFM signal in a first symbol of the signature part are the same, and an initial frequency of the first LFM signal in the prefix part meets:
$${f}_{pr}^{′} = {f}_{1} + {α}_{1} ( {T}_{1} - {T}_{pr}^{′} )$$
wherein
$${f}_{pr}^{′}$$
is the initial frequency of the first LFM signal in the prefix part, f₁ is an initial frequency of an LFM signal in the first symbol of the signature part, α₁ is the LFM rate of the LFM signal in the first symbol of the signature part, T₁ is a time duration of the first symbol in the signature part,
$${T}_{pr}^{′}$$
is a time duration of the first LFM signal in the prefix part, and
$${T}_{pr}^{′}$$
is less than or equal to T₁.

11. The apparatus of claim 8, wherein the prefix part comprises one LFM signal.

12. The apparatus of claim 8, wherein the prefix part comprises multiple LFM signals.

13. The apparatus of claim 12, wherein the multiple LFM signals comprise a first LFM signal in the prefix part and at least one other LFM signal, an LFM rate of an LFM signal in a first symbol of the signature part and an LFM rate of the at least one other LFM signal are the same, a time duration of the first symbol in the signature part and a time duration of the at least one other LFM signal are the same, and an initial frequency of the LFM signal in the first symbol of the signature part and an initial frequency of the at least one other LFM signal are the same.

14. The apparatus of claim 8, wherein:
the timing offset is obtained based on first K samples taken from the wake-up signal, K is a positive integer greater than 1, and
the first K samples are in the prefix part, or the first K samples are in the prefix part and a first symbol of the signature part.

15. A method comprising:
transmitting a wake-up signal comprising a prefix part and a signature part, wherein the prefix part comprises first at least one linear frequency modulated (LFM) signal, the signature part comprises second at least one LFM signal, a timing offset of the wake-up signal is obtained from the first at least one LFM signal in the prefix part, at least one parameter associated with the second at least one LFM signal in the signature part is obtained based on the timing offset, and the at least one parameter is used for a receiving apparatus to transition from a first mode to a second mode.

16. The method of claim 15, wherein the signature part comprises at least one symbol, and each symbol of the at least one symbol comprises a corresponding LFM signal among the second at least one LFM signal in the signature part.

17. The method of claim 16, wherein an LFM rate of a first LFM signal in the prefix part and an LFM rate of an LFM signal in a first symbol of the signature part are the same, and an initial frequency of the first LFM signal in the prefix part meets:
$${f}_{pr}^{′} = {f}_{1} + {α}_{1} ( {T}_{1} - {T}_{pr}^{′} )$$
wherein
$${f}_{pr}^{′}$$
is the initial frequency of the first LFM signal in the prefix part, f₁ is an initial frequency of an LFM signal in the first symbol of the signature part, α₁ is the LFM rate of the LFM signal in the first symbol of the signature part, T₁ is a time duration of the first symbol in the signature part,
$${T}_{pr}^{′}$$
is a time duration of the first LFM signal in the prefix part, and
$${T}_{pr}^{′}$$
is less than or equal to T₁.

18. The method of claim 15, wherein the prefix part comprises one LFM signal.

19. The method of claim 15, wherein the prefix part comprises multiple LFM signals.

20. The method of claim 19, wherein the multiple LFM signals comprise a first LFM signal in the prefix part and at least one other LFM signal, an LFM rate of an LFM signal in a first symbol of the signature part and an LFM rate of the at least one other LFM signal are the same, a time duration of the first symbol in the signature part and a time duration of the at least one other LFM signal are the same, and an initial frequency of the LFM signal in the first symbol of the signature part and an initial frequency of the at least one other LFM signal are the same.
